(19) United States
(12) Patent Application Publication
(10) Pub. No.: US 2013/0114607 A1
(43) Pub. Date: May 9, 2013

(54) Reference Architecture For Improved Scalability Of Virtual Data Center Resources

(71) Applicant: Jeffrey S. McGovern, West Berlin, NJ (US)

(72) Inventor: Jeffrey S. McGovern, West Berlin, NJ (US)

(21) Appl. No.: 13/483,916

(22) Filed: May 30, 2012

Related U.S. Application Data
(60) Provisional application No. 61/557,498, filed on Nov. 9, 2011.

(51) Int. Cl. H04L 12/56

(52) U.S. Cl. 370/395.53

(57) ABSTRACT

In an embodiment, a method for operating a data center includes interconnecting a hierarchy of networking devices comprising physical networking devices and virtual networking devices, such that physical networking devices are located at two or more higher levels in the hierarchy, and the virtual networking devices are located in at least one lower levels of the hierarchy. Virtual Local Area Networks (VLANs) are terminated only in physical networking devices located at the lowest of the two or more higher levels in the hierarchy.

### RELATED APPLICATION

This application claims the benefit of U.S. Provisional Application No. 61/557,498, filed on Nov. 7, 2011.

The entire teachings of the above application are incorporated herein by reference.

### TECHNICAL FIELD

This patent disclosure relates to efficient implementation of Virtual Data Centers (VDCs), and in particular to a reference architecture that provides improved scalability of VDC resources such as Virtual Local Area Networks (VLANs).

### BACKGROUND

The users of data processing equipment increasingly find the Virtual Data Center (VDC) to be a flexible, easy, and affordable model to access the services they need. By moving infrastructure and applications to cloud based servers accessible over the Internet, these customers are free to build out equipment that exactly fits their requirements at the outset, while having the option to adjust with changing future needs on a “pay as you go” basis. VDCs, like other cloud-based services, bring this promise of scalability to allow expanding servers and applications as business needs grow, without having to spend for unneeded hardware resources in advance. Additional benefits provided by professional level cloud service providers include access to equipment with superior performance, security, disaster recovery, and easy access to information technology consulting services.

Beyond simply moving hardware resources to a remote location accessible in the cloud via a network connection, virtualization is a further abstraction layer of VDCs that makes them attractive. Virtualization decouples physical hardware from the operating system and other information technology and resources. Virtualization allows multiple virtual machines with different operating systems and applications to run in isolation side by side on the same physical machine. A virtual machine is a software representation of a physical machine, specifying its own set of virtual hardware resources such as processors, memory, storage, network interfaces, and so forth upon which an operating system and applications are run.

### SUMMARY

Professional level data processing service providers are increasingly faced with challenges as they build out their own infrastructure to support VDCs and other cloud features. Even when they deploy large scale hardware to support many different customers, the promises of scalability and virtualization emerge as one of the service providers' biggest challenges. These service providers are faced with building out an architecture that can obtain a maximum amount of serviceability with a given set of physical hardware resources—after all, a single machine can only support a finite number of virtual machines.

In addition, service providers are faced with having to sometimes make trade-offs between customer expectations and the physical availability of resources. Customers expect the virtual data center to replicate their environment exactly and on demand, and so typically expect the service provider to immediate scale what is available. However, the service provider does not wish to spend money to deploy more hardware resources than absolutely necessary.

While these concerns over the available physical resources are real, so too is a strain put on the number of virtual resources as they vary, such as the number of available virtual switches, Virtual Local Area Network (VLANs), Media Access Control (MAC) addresses, firewalls, and the like. The services available are also constantly changing and depend, for example, upon the specific configuration and components of the VDCs as requested by customers. It would therefore be desirable for the service provider to have some control over the variables, such as the number of VLANs that can be supported by a particular data center.

The present disclosure is therefore directed to a reference architecture for a large scale cloud deployment environment having several improved attributes.

In one aspect, internetworking devices deployed at the data center are arranged in a hierarchy and configured to implement multi-tenant protocols, such as Multiprotocol Label Switching (MPLS), VLAN Trunking Protocol (VTP), Virtual Private LAN Service (VPLS), Multiple VLAN Registration Protocol (MRP) etc., but only at a certain level in the hierarchy. As an example, VLANs are terminated at the lowest level physical switch while higher levels in the hierarchy do not pass VLANs but rather pass routed protocols instead.

In an embodiment, a method for operating a data center includes interconnecting a hierarchy of networking devices comprising physical networking devices and virtual networking devices, such that physical networking devices are located at two or more higher levels in the hierarchy, and the virtual networking devices are located in at least one lower levels of the hierarchy. Virtual Local Area Networks (VLANs) are terminated only in physical networking devices located at the lowest of the two or more higher levels in the hierarchy. Layer 2 separation is maintained with VLANs in at least one virtual networking device.

The physical networking devices may include one or more data center routers, distribution layer switches and top-of-rack switches. The virtual networking devices may include one or more virtual switches and customer virtual routers.

The physical networking devices located at levels higher than the level that terminates VLANs may be terminated in one or more provider protocols.

The physical networking devices located at levels higher than the level that terminates VLANs may be terminated in one or more Layer 3 protocols.

In an embodiment, the hierarchy may include three levels, with a carrier block located at a top level, plural point of delivery (POD) access blocks located at a middle level and plural customer access blocks located at a bottom level. The carrier block may include at least one data center router and north bound ports of at least one distribution layer switch. Each POD access block may include one or more south bound ports of the at least one distribution layer switch, plural top-of-rack switches, and north bound ports of plural virtual switches. Each customer access block may include one of the plural virtual switches, a customer virtual router and plural virtual resources.

In an embodiment, each customer virtual router may be connected to corresponding interface IP addresses in corresponding VPN routing/forwarding instances on the distribution layer switch using a border gateway protocol.

With this arrangement, the data center provider can control exactly where the VLAN workload on data center switches starts, giving them maximum flexibility.

By making the VLAN constructs relevant only at the lowest physical level, the VDC customer is also exposing their private network segments to fewer locations in the network, and now can also use protocols such as MPLS to provide Layer 2 (L2) services to their resources.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 illustrates a reference architecture for implementing Virtual Data Centers (VDCs) at a service provider location.

FIG. 2 illustrates VDC customer connectivity into the data center.

### DETAILED DESCRIPTION

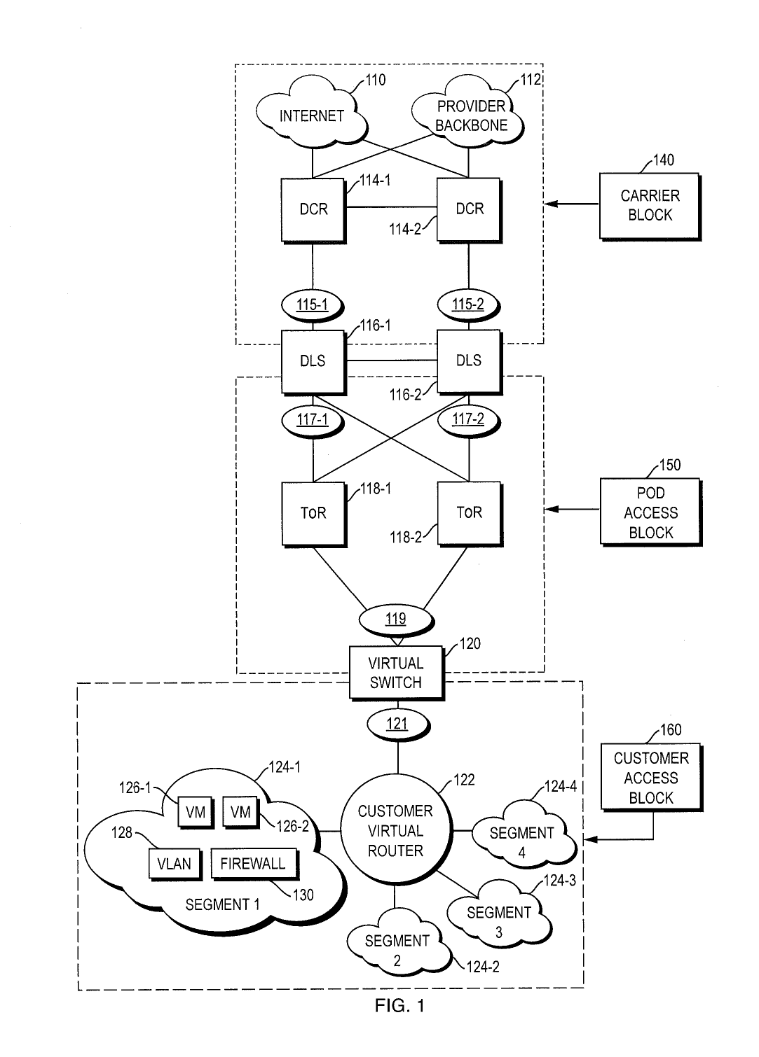

FIG. 1 is a diagram illustrating a reference architecture for a data center operated by a cloud services provider. A number of different types of physical and virtual machines make up the data center. Of particular interest here is that the data center reference architecture uses a number of internetworking devices, such as network switches, arranged in a hierarchy. These machines include highest level physical internetworking devices such as datacenter routers (DCRs) (also called Internet routers herein) 114-1, 114-2 that interconnect with the Internet 110 and provider backbone network 112. At succeeding levels of the hierarchy down from the highest level are distribution layer switches (DLSs) 116-1, 116-2 and then top-of-rack (ToR) switches 118-1, 118-2. The ToR switches 118 are the lowest level physical switch in the hierarchy.

At a next lower level of the hierarchy are virtual switches 120, and below that further are customer virtual devices, such as customer virtual routers 122, at the lowest level of the hierarchy.

One or more Virtual Data Centers (VDCs) are formed from virtual data processing resources such as the customer virtual router 122, virtual network segments (e.g., segment 1, segment 2, segment 3, segment 4) 124-1, 124-2, 124-3, 124-4 with each segment having one or more Virtual Machines (VMs) 126 and other virtualized resources such as VLANs 128 and firewalls 130.

It should be understood that various vendor product offerings may be used to implement the internetworking equipment at the different levels of the hierarchy. So, for example, a DCR 114 might be any suitable router supporting many clients and the services they have purchased from the provider. Examples include a Cisco AS9000, Juniper MX960 or similar large scale routers.

A DLS 116 is a switch that traditionally connects to the datacenter router and provides connectivity to multiple customers, or multiple services required by customers. Examples of these switches include Cisco 7010 or Juniper 8200, or similar class switches.

The ToR switches 118 are those that traditionally connect to the resources that the customer owns or the infrastructure that makes up a service that the provider is selling. These may be, for example, Cisco 6210 or Juniper EX4200 class switches.

The virtual switch 120 is a software switch which is located in a hypervisor that provides connectivity to the virtual infrastructure that a customer owns or the virtual infrastructure that a provider is selling (such as the VDCs). Examples include the Cisco Nexus 1000V and VMW are distributed virtual switch.

It should be understood, however, that the novel features described herein are not dependent on any particular vendor's equipment or software and that other configurations are possible.

Combinations of the functional blocks are referred to herein with different labels for ease of reference. For example the DCRs 114-1, 114-2 and DLSs 116-1, 116-2 are referred to as a “Carrier Block” 140; the down-level facing ports 117-1, 117-2 of the DLS 116-1, 116-2, the ToR switches 118-1, 118-2, and up-level facing ports 119 of the virtual switch 120 are referred to as the “POD Access Block” 150; and the down-level facing ports 121 of the virtual switch 120 and the rest of the lower level components (such as the customer virtual router 122 and VMs 126) are referred to as the “Customer Access Block” 160.

The DCRs 114 provide all ingress and egress to the data center. As depicted in FIG. 1, two DCRs 114-1, 114-2 provide redundancy and failover capability, avoiding single points of failure. The DCRs establish connectivity to external networks such as the Internet 110 but also to the service provider's own private networks such as indicated by the provider network 112, which in turn provides a backbone connection into an MPLS network that interconnects different data centers operated by the service provider in disperse geographic locations. Traffic originating from customers of the service provider also originates via the provider network 112.

Devices in the Carrier Block 140 are responsible for moving traffic to and from the POD Access Block 150, providing access to locations outside the service provider's data center and destined for the Internet 110 and/or the other service provider areas accessible through the provider network connection 112. As described in more detail below, devices located in the Carrier Block 140 serve as aggregation points which terminate VLANs.

The POD Access Block 150 is a section of the referenced architecture that holds multiple customers VDCs. In a given physical data center there may be for example a number of PODs, such as at least a dozen or more PODs. The number of PODs in a physical data center depends on the physical hardware used to implement the processors and the types of physical switches.

The Customer Access Block 160 is made up of individual customer's virtual equipment. This level thus refers to the resources available to an individual customer whereas the POD Access Block 150 level may typically support a group of customers.

The DCRs 114 terminate all Internet access as well terminating access for multiple customers within multiple service areas. These routers do this using Multi-Protocol Label Switching (MPLS), a Layer 3 (L3) protocol, as a transport to maintain separation of customer data. Furthering this concept in the reference architecture, the switches at the top level of the hierarchy, namely, DLS 116 in the example described herein, also extend these capabilities.

At the Customer Access Block level 160, a unit of physical resource measure is the POD. In this reference architecture, each POD preferably consists of a 42U standard sized rack. Such a rack is configured to hole a number of physical servers, which may be a dozen or more physical servers. The physical servers in turn provide a much larger number of VMs. Each POD typically has a pair of top-of-rack switches 118 to provide access up the hierarchy to the distribution layer switches 116, and down to the virtual switch 120, and customer virtual routers 122 to provide access down the hierarchy.

The highest level switches in the hierarchy, such as the distribution layer switches 116, are required to move the most amount of traffic and therefore tend to be relatively expensive. Furthermore, since these switches are responsible for moving all of the customer's traffic between the Customer Access Block 160 and the Carrier Block 140, VLAN resources tend to be exhausted quickly in multi-tenant environments. This in turn affects the amount of customer defined virtual resources that the overall data center can support, representing revenue loss and a scaling problem for the service provider.

To overcome this difficulty, the reference architecture specifies where VLAN-termination points will be implemented by physical devices and where they will not be implemented. In particular, the down-facing ports 117 on the distribution layer switches 116 are the first place where VLAN-termination points are handled and should be terminated in a provider protocol such as MPLS. The up-facing ports 115 on the distribution layer switches 116 and the DCRs 114 should not pass VLANs, thus isolating the VLAN consumption as far down in the hierarchy as possible—which means closer to the customer. Pushing the VLAN lower, further down the hierarchy, and as close to the VDCs as possible gives the service provider more control over the physical resources needed to implement VLANs.

With this approach, the ToR switches 118 now become the highest level switch in the hierarchy where only Layer 2 addressing is relevant. This permits the high level switches to remain simple and thus to have additional resources available for supporting more connections.

Customer Internet access and access to other provider-based services is granted through the DCRs 114. In the reference architecture this is still provided by traditional routing protocols such as static, Open Shortest Path First (OSPF), or Border Gateway Protocol (BGP) between the Customer Access Block 160 and the Carrier Block 140.

BGP is a path vector protocol backing the core routing decisions on the Internet. It maintains a table of IP networks or ‘prefixes’ which designate network reach-ability among autonomous systems (AS). BGP effectively determines how an AS, or independent network, passes packets of data to and from another AS. Rather than depend on a calculated metric to determine the best path, BGP uses attribute information that is included in route advertisements to determine the chosen path.

When BGP runs between two peers in the same AS, it is referred to as Internal BGP (IBGP or Interior Border Gateway Protocol). When BGP runs between autonomous systems, it is called External BGP (EBGP or Exterior Border Gateway Protocol). Routers on the boundary of one AS exchanging information with another AS are called border or edge routers. A provider edge (PE) device is a device between one network service provider's area and areas administered by other network providers. A customer edge (CE) device is a customer device that is connected to the provider edge of a service provider IP/MPLS network. The CE device peers with the PE device and exchanges routes with the corresponding VPN routing/forwarding instances (VRFs) inside the PE using a protocol such as EBGP.

Each VPN is associated with one or more VRF. A VRF defines the VPN membership of a customer site attached to a PE device. A VRF includes an IP routing table, a forwarding table, a set of interfaces that use the forwarding table, and a set of rules and routing protocol parameters that control the information that is included in the routing table.

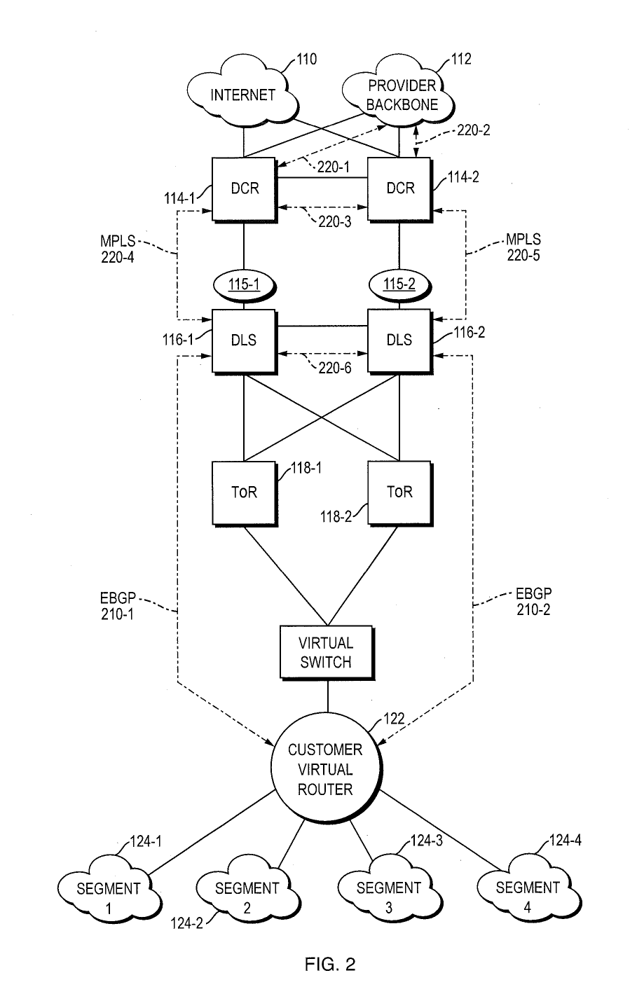

As shown in FIG. 2, the distribution layer switches 116 become the provider edge devices and EBGP connections 210-1, 210-2 are run from the customer's virtual router 122 (as a customer edge device) in the Customer Access Block 160 to each of the interface IP addresses in their VRF on the distribution layer switches 116-1, 116-2. As noted above, a provider protocol is operated between up-facing ports 115-1, 115-2 on the DLS 116 and the DCRs 114 shown in FIG. 2 as MPLS at 220-1, . . . 220-6.

The advantages of the approach disclosed herein can be understood by contrasting it with a traditional approach to the problem. Traditionally, without the improved reference architecture described above, the DCRs would be configured to provide all the customer's layer 3 (L3) access within the service area and would run provider protocols to connect to other services within the provider network. The DLS, ToR, and virtual switches would all run layer 2 (L2) constructs such as VLANs to separate tenants from one and other. For example, consider an average VDC that is built to the following specifications: 5 VLANs (outside connection to Internet, web tier, application tier, database tier, management), and 10 virtual resources. If the provider's infrastructure is built from switches that can all support the 802.1Q standard of 4,000 VLANs this means that the DLS switches could support 800 customers and 8,000 virtual resources before a new POD access and customer access block would have to be purchased. If the provider's server infrastructure can support 40 customer virtual devices per server the provider could only implement 200 servers in this infrastructure before having to purchase all new devices in the POD access and customer access blocks.

For most providers, the above example does not support enough customers on the initial capital expenditure. In an attempt to fix the problem, providers have moved different protocols into each of these areas but these moves have generated complexity or forced the provider to move to protocols that are brand new and untested in production environments. By moving more intelligence out of the carrier block and into the POD access block, as described above with reference to FIGS. 1 and 2, provides much larger economies of scale while also maintaining the existing structure of the datacenter and service offerings for the provider.

By moving this intelligence, as described herein above, provider protocols (MPLS) now drop down into the POD access layer. This means that VLANs are now only significant on the south bound ports of the DLS switches, the ToR switches, and the virtual switches rather than being significant and limiting for the entire DLS switch. Because we have limited the scope of significance within the service area to just the south bound ports, the provider can then choose the DLS switches intelligently such that these switches can implement provider protocols and will also support multiple instances of the VLAN standard.

Now using the same example, but using the inventive approach disclosed herein, an average VDC is still built to the following specifications: 5 VLANs (outside connections to Internet, web tier, application tier, database tier, management), and 10 virtual resources. Now that we have changed the significance of where VLANs are significant we only have to worry that the ToR and virtual switch support the entire 802.1Q specification. If they do, the service provider can now build infrastructure such that each POD access block will support 4,000 VLANs which from the example above we know that will support 800 customers and 8,000 virtual resources. However, unlike above where the service provider would have had to purchase new DLS switches, new ToR switches, and new virtual switches, the service provider will now only have to purchase new ToR and new virtual switches and connect them to the DLS switches. This means that the service provider can now support as many POD access connections as the DLS switches south bound ports will support.

Another way to view this is 8,000 virtual machines times the number of POD access blocks. In the example above we had determined that the provider could only support 200 servers per set of DLS switches. In the improved reference architecture the provider could implement 200 servers in each individual POD access and customer access block if that made sense to them.

With this approach, the enterprise cloud solution and the provider's physical models can be reproduced interchangeably.

It should be understood that the example embodiments described above may be implemented in many different ways. In some instances, the various “data processors” or networking devices described herein may each be implemented by a physical or virtual general purpose computer having a central processor, memory, disk or other mass storage, communication interface(s), input/output (I/O) device(s), and other peripherals. The general purpose computer is transformed into the processor and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

While this invention has been particularly shown and described with references to example embodiments thereof, it will be understood by those skilled in the art that various changes in form and details may be made therein without departing from the scope of the invention encompassed by the appended claims.

What is claimed is:

1. A method for operating a data center comprising:
interconnecting a hierarchy of networking devices comprising physical networking devices and virtual networking devices, such that physical networking devices are located at two or more higher levels in the hierarchy, and such that the virtual networking devices are located in at least one lower levels of the hierarchy; and
terminating Virtual Local Area Networks (VLANs) only in physical networking devices located at the lowest of the two or more higher levels in the hierarchy.

2. The method of claim 1 further comprising maintaining Layer 2 separation with VLANs in at least one virtual networking device.

3. The method of claim 1 wherein the physical networking devices include one or more data center routers, distribution layer switches and top-of-rack switches.

4. The method of claim 1 wherein the virtual networking devices include one or more virtual switches and customer virtual routers.

5. The method of claim 1 further comprising terminating the physical networking devices located at levels higher than the level that terminates VLANs in one or more provider protocols.

6. The method of claim 1 further comprising terminating the physical networking devices located at levels higher than the level that terminates VLANs in one or more Layer 3 protocols.

7. The method of claim 1 wherein the hierarchy comprises three levels, with a carrier block located at a top level, plural point of delivery (POD) access blocks located at a middle level and plural customer access blocks located at a bottom level; the carrier block comprising at least one data center router and north bound ports of at least one distribution layer switch; each POD access block comprising one or more south bound ports of the at least one distribution layer switch, plural top-of-rack switches, and north bound ports of plural virtual switches; each customer access block comprising one of the plural virtual switches, a customer virtual router and plural virtual resources.

8. The method of claim 7 further comprising connecting each customer virtual router to corresponding interface IP addresses in corresponding VPN routing/forwarding instances on the distribution layer switch using a border gateway protocol.

9. A data center system comprising:
plural physical networking devices;
plural virtual networking devices;
wherein the physical networking devices and the virtual networking devices are interconnected in a hierarchy in which physical networking devices are located at two or more higher levels in the hierarchy, the virtual networking devices are located in at least one lower level of the hierarchy, and in which only physical networking devices located at the lowest of the two or more higher levels are configured to terminate Virtual Local Area Networks (VLANs).

10. The data center system of claim 9 configured such that Layer 2 separation with VLANs is maintained in at least one virtual networking device.

11. The data center system of claim 9 in which the physical networking devices include one or more data center routers, distribution layer switches and top-of-rack switches.

12. The data center system of claim 9 in which the virtual networking devices include one or more virtual switches and customer virtual routers.

13. The data center system of claim 9 in which the physical networking devices located at levels higher than the level that terminates VLANs terminate in one or more provider protocols.

14. The data center system of claim 9 in which the physical networking devices located at levels higher than the level that terminates VLANs terminate in one or more Layer 3 protocols.

15. The data center system of claim 9 in which the hierarchy comprises three levels, with a carrier block located at a top level, plural point of delivery (POD) access blocks located at a middle level and plural customer access blocks located at a bottom level; the carrier block comprising at least one data center router and north bound ports of at least one distribution layer switch; each POD access block comprising one or more south bound ports of the at least one distribution layer switch, plural top-of-rack switches, and north bound ports of plural virtual switches; each customer access block comprising one of the plural virtual switches, a customer virtual router and plural virtual resources.

16. The data center of claim 15 in which each customer virtual router is connected to corresponding interface IP addresses in corresponding VPN routing/forwarding instances on the distribution layer switch using a border gateway protocol.
